(19) United States
(12) Patent Application Publication
(10) Pub. No.: US 2019/0112905 A1
(43) Pub. Date: Apr. 18, 2019

(54) Mobile Gas Compression System for Well Stimulation

(71) Applicant: Certarus Ltd., Calgary (CA)

(72) Inventors: Nathan Ough, Calgary (CA); Rod Saville, Calgary (CA)

(21) Appl. No.: 16/159,203

(22) Filed: Oct. 12, 2018

(30) Foreign Application Priority Data
Oct. 13, 2017 (CA) 2982281

(51) Int. Cl. E21B 43/16; C09K 8/594; E21B 43/26

(52) U.S. Cl. CPC E21B 43/166; E21B 43/26; E21B 43/164; C09K 8/594

(57) ABSTRACT

Mobile system for the compression of a fluid for use in oil operations, said mobile system comprising:
a trailer adapted for the transport of a fluid compression unit fixedly mounted thereon, said trailer being adapted for transport on conventional roadways, said fluid compression unit comprising:
   an inlet operatively connected to a fluid source;
   a compressor adapted to compress a fluid to high pressures; and
   an outlet adapted to be operatively connected to a well for downhole injection of said fluid while under substantially the high pressure reached during the compression by the compressor;
wherein, when in operation, said compressed fluid is injected into a well at a pressure of no less than 7,000 psi.

### FIELD OF THE INVENTION

The present invention is directed to a mobile unit for gas compression, more specifically, a mobile unit for well stimulation by ultra-high pressure gas.

### BACKGROUND OF THE INVENTION

Unconventional reservoirs present unique challenges for energy producers and oil field service companies seeking to extract the maximum economic lifetime potential from their wells. These reservoirs are defined by their low permeability, low-to-no porosity, and need for stimulation for economic production. No two formations are alike, and often they are characterized by significant variability within the same formation, thus requiring varying stimulation techniques. Unleashing the value of these unconventional reservoirs relies heavily on the methods of horizontal drilling combined with hydraulic fracturing.

The vast majority of the fracturing fluids used in shale and tight sand plays are water-based systems, predominantly slickwater or gelled water. However, carbon dioxide and nitrogen share a long and successful history in hydraulic fracturing and well stimulation, including energizing water-based fluids. Energized fluids can be defined as fracturing fluids that include at least one compressible, sometimes soluble, gas phase. Studies indicate that fracturing with solutions energized by CO₂ or N₂ can economically achieve significantly more hydrocarbon recovery than nonenergized approaches. One such study found that using energized fluids improved well performance by 1.6-2.1 times, compared with nonenergized solutions.

There is a clear benefit to using energized fluids in the form of improved well productivity, but there also is added upfront cost for the CO₂ or N₂ supply and mobilizing the equipment needed on the well location.

The goal of well stimulation is to achieve the maximum productivity over the life of the well Expected Ultimate Recovery (“EUR”) at the lowest unit cost while maximizing the area under the decline curve. Fracturing with fluids that are not energized can leave liquids trapped in low-permeability, tight, depleted or water-sensitive formations. Fluid remaining in the formation negatively impacts the physical properties of the rock, lowering the conductivity of the reservoir and reducing or impeding the flow of oil and gas.

In many hydrocarbon-bearing formations, water is the wetting phase and the initial water saturation is very low. The invasion (imbibition) of water from the fracturing fluid can be very detrimental to hydrocarbon productivity, since any additional water remains trapped because of capillary retention. The increase in water saturation significantly reduces the formation's relative permeability to hydrocarbons, sometimes by orders of magnitude. Clay swelling in water-sensitive formations also can reduce productivity. Clays swell as water invades the formation and contacts the rock around the fracture. The resulting increase in formation skin reduces the ability of the hydrocarbons to flow from the reservoir to the fracture. Additionally, hydrocarbon transport can be impaired inside the fracture. In many shales and clay-rich sands, the conductivity of the proppant pack drops considerably in the presence of water. The rock-to-fluid interactions soften the rock, further promoting proppant embedment as the rock closes on the proppant.

Energizing the fracturing fluid with CO₂ or N₂ reduces the amount of water necessary to pump the frac job, lowers the leak-off of the water phase, and improves flow back, since the invaded water saturation is lower. In other words, energized fracturing fluids improve the total flow-back volume and rate, and when foamed, significantly lower the total and liquid leak-off coefficient to minimize fluid retention. The flexibility of energized solutions allows hydraulic fracturing fluids to be mixed according to the technological needs of unconventional reservoirs. They provide more rapid and complete fluid recovery, help to clean without swabbing, and reduce formation damage by minimizing the amount of aqueous fluids introduced into the formation. Energized solutions have superior proppant transport properties without creating ultrahigh molecular weight polymer structures (cross-linking), and in the case of underpressured or depleted zones, provide enhanced energy for hydrocarbon recovery. In unconventional reservoirs, energized solutions provide the necessary energy to move hydrocarbons in low-pressure zones or areas with strong capillary forces, because not as much water invades the formation. The solubility and miscibility properties of CO₂ provide greater opportunity to energize the flow of higher viscosity hydrocarbons.

Avoiding reservoir damage during stimulation that could inhibit or restrict hydrocarbon flow is critical. Proppant, in effect, can cause damage. Too little or too much proppant, improperly placed or poor-quality proppants, and proppant embedment in reservoir rock all can result in damage or blockage that reduces the flow of oil and gas. Liquid leak-off increases water saturation, thereby decreasing the formation's relative permeability to gas. This may play a significant role in damaging gas reservoirs. Energized solutions, however, use less water than conventional fracturing treatments and provide energy for recovering induced fluids while decreasing the fluid leak-off potential to minimize reservoir damage. Less water means less potential for clay swelling, fines migration, liberating hydrogen sulfide, forming emulsion, and fluid retention. Less damage enhances flow for effective flow back, reducing the time it takes to move to production, while increasing overall production.

Energized solutions are ideal for reservoirs with low permeability, water sensitivity, underpressured or depleted zones, or poor flow back caused by low pressure or strong capillary forces. They also are used for refracturing wells where production has declined. Because they can be foamed or emulsified to cover a range of viscosities to provide superior proppant-transport properties with slow settling rates, they are good for shales that require fracture length or reservoirs rich in liquids that benefit from fracture width. When foamed, energized solutions significantly reduce fluid leak-off into the formation as well as reduce gel volume requirements, thereby improving fracture conductivity.

In the Montney and Cardium shales, energized fluids dramatically improved well performance, compared with non-energized solutions. Energized solutions can significantly increase well productivity more cost effectively, presenting opportunities to reduce fracturing resources such as water and proppant volumes, and to reduce injection rates and injection pressures. Moreover, they are ideally suited for use in tight, depleted or water-sensitive formations, or to enhance the mobility of more viscous hydrocarbons around and through the wellbore, especially in under pressured reservoirs.

To realize the full potential value of an oil field and to achieve the highest recovery factor, using energized fluids during each stage of the recovery process is the best way to achieve optimal results. But achieving a field's full potential value also means optimizing recovery along with the costs of that production. Energized fluids offer the means to maximize the recovery factor and, importantly, if planned from a field-wide perspective, the means to optimize the cost of production.

To strive for the greatest EUR of the well in the most economically effective way, both performance and economy must be considered or maximum productivity over time at the lowest overall cost. Typically, EUR is projected over 10 years based on actual production rates taken at 30 days, 60 days and 90 days. The decline curve, representing the drop in production over time, is projected from these actuals, with low, best and high estimates to cover the range of uncertainty.

However, much of the focus is, too often, on the well's initial performance. Encouraged by time-to-production using familiar techniques such as water, producers might neglect to consider alternatives that could minimize the slope of the decline curve. Adding CO₂ or N₂ to the fracturing treatment has been shown to optimize overall productivity (increasing EUR), even though the initial acquisition cost of these gases can be higher than nonenergized fluids such as slick or acid water. However, beyond their ability to improve fracturing itself, energized fluids significantly boost flowback and production performance through enhanced cleanup and minimal fluid retention. They also boost production significantly in depleted formations. Additional upfront capital investment can range from $100,000 USD -$500,000 USD per well completions. In today's economic environment, producers have shifted away from energized fracs given the need for quicker return of capital sometimes to the detriment of better long term economics.

Despite the known energized oil recovery process, there remains a deep seated need for a more efficient method which takes into account more than a near-sighted focus on increased oil production.

The present invention intends of overcoming most of the drawbacks of the prior art by using gas present on site (such as natural gas) and converting it to a high pressure natural gas through the use of a mobile gas compression unit adapted to be transported on regular roadways. The present invention provides a commercially-viable solution to a substantial problem and, in its implementation, can resolve or, at least minimize, a multitude of disadvantages or concerns inherent with current fracking practices.

### SUMMARY OF THE INVENTION

The inventors have devised a novel method for well stimulation which takes into account a multitude of environmental, engineering and technical factors to achieve a more efficient oil recovery all the while being less environmentally damaging than other fracking processes.

The inventors have ingeniously developed a novel method of performing energized oil recovery by taking advantage of gas sources present on an oilfield and processing this gas with a novel mobile system to compress it to ultra-high pressures for subsequent use in well stimulation.

According to an aspect of the present invention, there is provided a mobile system for compressed gas well stimulation, said mobile system comprising:
a first gas compression unit; said first gas compression unit comprising:
   an inlet operatively connected to a source; and
   a first compressor adapted to compress the gas to a high pressure;
   and an outlet;
a second gas compression unit; said second gas compression unit comprising:
   an inlet operatively connected to the outlet of the first gas compression unit;
   a second compressor adapted to compress the compressed gas to a pressure of no less than 7,000 psi; and
   an outlet adapted to be operatively connected to a well to perform well stimulation.

Preferably, said compressed gas can reach pressures of no less than9,000 psi. More preferably, said compress gas can reach pressures of no less than 13,000 psi.

According to a preferred embodiment of the present invention, the first gas compression unit is on a first trailer and the second gas compression unit is on a second trailer.

Preferably, the mobile system further comprises a power source operatively connected to both first and second gas compression units. According to another preferred embodiment, the first gas compression unit can be powered by a natural gas direct drive motor while the second gas compression unit is powered by an electrical power source.

Preferably also, at least one of the two gas compression units further comprise a coolant system operatively connected to the compression unit.

According to a preferred embodiment of the present invention, the second compression unit comprises a motor located side-by-side with the second compressor on a trailer to allow said mobile system to be transported on conventional roadways.

Preferably, the second compressor is a reciprocating compressor.

According to a preferred embodiment of the present invention, the gas to be compressed is obtained from an onsite source selected from the group consisting of: an existing well; an existing pipeline and an existing facility. Preferably, the gas is recovered from an existing well and fed to the first gas compression unit. According to another preferred embodiment, the gas is recovered from an existing pipeline or an existing facility and fed to the first gas compression unit.

According to another aspect of the present invention, there is provided a method for well stimulation by injection of compressed gas, said method comprising:
providing a mobile system for compression of gas up to a pressure of no less than 7,000 psi, said mobile system comprising:
a gas compression unit; said gas compression unit comprising an inlet operatively connected to a source and an outlet operatively connected to a well for downhole injection of said compressed gas while under substantially the high pressure reached during the compression;
providing a source of gas;
fluidly connecting the source of gas with the mobile unit for gas compression;
flowing the gas to the mobile system for gas compression;
compressing the gas up to a pressure of not less than 7,000 psi; and
injecting the compressed gas into a well to be stimulated.

According to a preferred embodiment, the compressed gas is mixed with a fluid such as water, oil or the like prior to injection into a well.

According to another aspect of the present invention, there is provided a method for well stimulation by injection of compressed gas, said method comprising:
providing a mobile system for compression of gas up to a pressure of no less than 7,000 psi, said mobile system comprising:
a first gas compression unit; said first gas compression unit being operatively connected to a source;
a second gas compression unit; said second gas compression unit being operatively connected to the first unit and having an outlet adapted to be operatively connected to a well for downhole injection of said gas while under substantially the high pressure reached during the compression by the second unit;
providing a source of gas;
fluidly connecting the source of gas with the mobile system for gas compression;
flowing the gas to the mobile unit for gas compression;
compressing the gas up to a pressure of not less than 7,000 psi; and
injecting the compressed gas into a well to be stimulated.

Preferably, the gas is compressed up to a pressure of no less than 9,000 psi. More preferably, the gas is compressed up to a pressure of no less than 13,000 psi.

According to yet another aspect of the present invention, there is provided a mobile system for compressed gas well stimulation, said mobile system comprising:
a trailer adapted for the transport of a gas compression unit fixedly mounted thereon, said trailer being adapted for transport on conventional roadways;
said gas compression unit; comprising:
an inlet operatively connected to a gas source;
a compressor adapted to compress gas to high pressures; and
an outlet adapted to be operatively connected to a well for downhole injection of said gas while under substantially the high pressure reached during the compression by the compressor;
wherein, when in operation, said compressed gas is injected into a well at a pressure of no less than 7,000 psi. Preferably, the gas is natural gas, which comprises methane.

According to a preferred embodiment of the present invention, oil and gas shale stimulation by using natural gas, can significantly reduce water consumption; reduced flaring; achieve up to a 100% reduction in CO₂ and N₂; reduce the HP required on site; result in costs savings across completions process; reduce the footprint; reduce lease traffic; and open up new areas for activity where water supply is a constraining factor along with potential significant production enhancement when compared to CO₂ and N₂.

While stimulation using natural gas may not be appropriate in certain cases, it may be desirable in areas where the local gas supply is significant. While it may require a gas scrubber, the advantages of the present invention greatly outweigh the present methods using water as main fluid or energized fracs requiring the shipment of N₂ or CO₂ to a site. Accordingly, a well designed methane-based energized completion has significant potential to provide economic, EUR/production enhancement and environmental benefits.

### BRIEF DESCRIPTION OF THE FIGURES

The present invention may be better understood in consideration of the following description of various embodiments of the invention in connection with the accompanying figures, in which:

FIG. 1 is a perspective view of a location including the equipment where a well is being stimulated; and

FIG. 2 is a perspective view of a mobile unit for compressing gas according to a first embodiment of the present invention.

### DETAILED DESCRIPTION OF THE PREFERRED EMBODIMENT

While the compression of gases, such as natural gas, up to pressure of 13,000 psi can be done where large facilities exist, there are no known mobile compressors which can accomplish this task.

In light of this technological hurdle, other companies choose to use methane in other ways. For example, several patents discuss the use of liquid natural gas (LNG) for the stimulation of formations (i.e. fracking). These include CA 2,879,555; CA 2,824,206; CA 2,824,181; and CA 2,824,169. These known prior art patents discuss the liquefaction of natural gas and transport to an oilfield to be compressed prior to being mixed with a carrier fluid and injected downhole for stimulation of a formation. However, this has not yet been put into practice for the sole reason that liquid natural gas would have to be shipped in quantities of hundreds of trucks per day to an oilfield in order to carry out fracking operations. Otherwise, the site would have to have its own natural gas liquefaction plant in order to capture natural gas flowing out of an existing well and convert it to liquid natural gas. Moreover, liquid natural gas is quite dangerous and, as such, it is desirable to limit potential exposure and any potential interaction between humans and this liquid.

In order to build a fixed gas compression facility in an oilfield there are many logistical hurdles which are encountered. Firstly, in order to install a fixed compressor unit capable of reaching high pressures such as 7,000 psi, more preferably 9,000 psi and even more preferably, 13,000 psi, one would have to pour a concrete foundation of roughly 600 tons. This is a measure which costs in the vicinity of 1 million US dollars. The initial cost for piping is also in the range of 1 million US dollars for both a fixed compression system or a mobile system as disclosed in the present description.

The second factor to consider is that a gas compression system used for well stimulation only needs to be on site for a period generally ranging from 2 weeks to 2 months, in most cases. If one were to install a fixed compression system, the system would become obsolete generally within 2 months at the most, while a mobile system can be moved to another location once the well stimulation activities are completed at a first well. This avoids the waste of concrete foundations, as mentioned above, having utility for at most 2 months.

Fixed or permanent facilities when compared to the novel approach disclosed herein at least double the completion costs of a well compared to the use of a mobile compression system as disclosed and claimed herein.

The inventors have, through inventive re-engineering of a compression system managed to decrease the number of components, optimized the piping arrangement, balanced equipment and the positioning of equipment on a trailer and have managed to reduce the total weight of a compression system which is typically in the range of 600-700 tons by removing several hundreds of tons of equipment. This multi-prong approach at the re-design of a high pressure gas compression system to enable it to become mobile has ensured that a preferred embodiment of the system to be transportable by trailer on conventional roadways.

According to a preferred embodiment of the present invention, the mobile compression system will be capable of receiving a gas and sending the compressed gas into a well for well stimulation where the pressure of the compressed gas will be of at least 7000 psi. According to a preferred embodiment, the compressed fluid may comprise gas comingled with a liquid as can be routinely found on site in the field. More preferably, the pressure of the compressed gas exiting the compression system will be in the range of 7000-13000 psi and more. According to another preferred embodiment of the present invention, the compressed gas exits the compression system at a pressure above 13000 psi and enters the well to perform effective well stimulation. According to another preferred embodiment of the present invention, the compressed gas can be mixed with a fluid prior to its injection into a well.

Preferably, to maintain the weight of the mobile gas compression system to a strict minimum, it is preferable to eliminate the presence of gas scrubbers on the trailer, as well as power supply. According to a preferred embodiment of the present invention, the mobile gas compression system does not require the presence of a concrete pad.

According to a preferred embodiment of the present invention, the compressor used on a mobile gas compression system is a reciprocating compressor. This type of compressor is desirable to use as it can provide high pressures and is not as sensitive as other types of compressors when considering transport is one of the desirable aspects of the present invention. Indeed, turbine compressors are capable of reaching high pressure but are sensitive to vibrations, shaking and other undesirable effects of transporting equipment from one site to another. As well, turbine compressors are sensitive to flow variations and are simply not as versatile as reciprocating compressors. Screw compressors are not known to reach pressures much above 4500 psi and as such, would be less desirable for the proposed applications.

According to a preferred embodiment of the present invention, there is provided a mobile compression system capable of compressing gases at pressures of up to 13,000 psi or more and said mobile compression unit being capable of being transported on most standard roadways. A standard roadway should be understood by the person skilled in the art of the present invention that the Interstate Highway standards for the U.S. Interstate Highway System uses a 12-foot (3.7 m) standard for lane width, while narrower lanes are used on lower classification roads.

According to a preferred embodiment of the present invention, the mobile system for high pressure gas compression for use in fracking by methane (gas) injection is designed to mitigate the additional upfront costs associated with energized fracs. These include but are not limited to, reduced water consumption; reduced flaring of gases; reduced noise and diesel emissions; and reduced trucking costs related to energized gases. Associated costs which are not often considered include driver's salaries, and truck maintenance costs, insurance costs, all of which are significant and economies in each category every day amounts to substantial savings over the long run.

According to a preferred embodiment of the present invention, a well designed methane-based energized completion has significant potential to provide economic, EUR/production enhancement and environmental benefits. The economic benefits include: reduced water costs associated with: acquisition; transfer; disposal; and recycling; reduced horse power costs; potential to reduce proppant costs; fuel cost reduction; labor and associated service cost reduction; reduced carbon levy and taxes; and significant cost reduction compared to N₂ and CO₂ completions.

According to a preferred embodiment, the EUR/production enhancement comes from at least one of the following: improving conductivity of the reservoir; reducing water damage and water retention; reduced clay swelling; minimizing water blockage; mitigate downhole offset communication (results in a net benefit); limiting clay absorption of proppant; boosting EURs 1.6-2.1 times; and energizing depleted reservoirs maximizing production

The environmental benefits from a process according to a preferred embodiment of the present invention include: an increased social license from mitigation of fresh water usage; limiting future exposure to drought restrictions; having the ability to flow back to production without flaring; significantly reducing truck traffic; reducing diesel emissions; reducing noise emissions; limiting water contamination and associated environmental liabilities. The reductions in truck traffic and diesel emissions would according to a preferred embodiment result in the use of onsite natural gas which would be compressed by the device according to a preferred embodiment of the present invention.

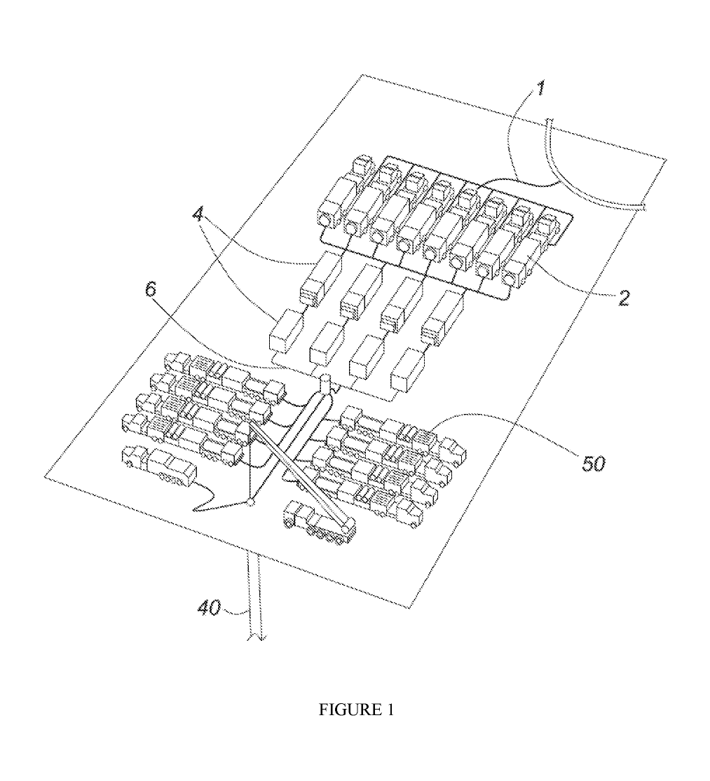

According to a preferred embodiment of the present invention as illustrated in FIG. 1, the mobile system for compression of gas up to a pressure of no less than 7,000 psi, comprises a first gas compression unit (2); said first gas compression unit being operatively connected to a source of gas (1). Preferably, the gas will come from a well located onsite, but the gas could also come from a pipeline or a facility located on site or close thereto. This source of gas is highly desirable as it eliminates the need to transport gases such as CO₂ or N₂ to an oilfield. The first gas compression unit takes in the gas and compresses it to yield a pressurized gas preferably at a pressure of 4500 psi. This pressurized gas is then fed into a second gas compression unit (4). The second gas compression unit is operatively connected to the first unit. The second gas compression unit is adapted to take in the pressurized gas and pressurize it to a higher pressure, preferably up to at least 13,000 psi. This highly pressurized gas is then injected into a well (40) to perform a pressure pumping operation or an enhanced oil recovery operation. Preferably, there are trailers (50) containing fracturing fluid and/or proppant located onsite which will provide fluid and/or proppant for the well stimulation. In this case, the pressurized gas piping (6) leads the pressurized gas to be mixed with fracturing fluid and/or proppant and is then injected into the well (40). According to another preferred embodiment, the highly pressurized gas could be replaced with an oil-based fluid (liquid).

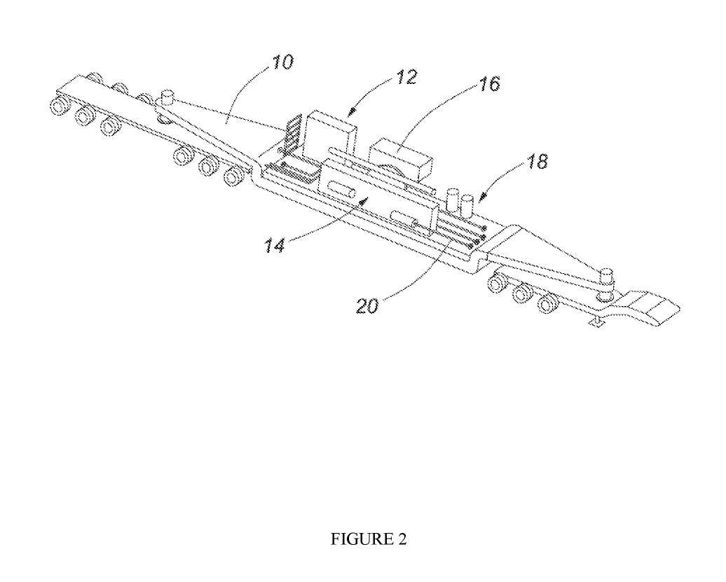

As illustrated in FIG. 2, the mobile system for fluid compression comprises a trailer (10), a PLC unit (12), a reciprocating compressor (14) actuated by a main motor (16), a coolant system (18) operatively connected to the main motor and gas piping (20). The gas piping allows the gas to be circulated into the compressor from a source and out of the compressor to be injected to perform well stimulation. The arrangement of the equipment on the trailer and the balancing thereof as well as the elimination of certain elements from the trailer has allowed the inventors to design a self-contained gas compression unit for compression of gas at high pressures, said unit which can be transported on conventional roads. This allows oil and gas operators access to substantially more wells which were previously considered out of reach for logistical reasons, for example wells requiring the installation of a permanent compression unit. The term self-contained is meant to be understood by the person skilled in the art to refer to the fact that all of the equipment required to compress the gas is located on a trailer. Equipment such as power sources which are commonly present on their own mobile units are understood to be separate from the gas compression step.

According to a preferred embodiment, the mobile compression system can be set up on an oil well (or on a gas well) site in less than about 72 hours. Similarly, it can be disconnected and made available to move to another site in less than 72 hours.

According to a preferred embodiment of the present invention, the mobile compression system can lead to reductions of water usage of up to 30% when performing well stimulation. More preferably, the water usage may be reduced by about 50% compared to conventional well stimulation need for water. Most preferably, the water usage may be reduced by about at least 70%.

Preferably, when gas is being retrieved from a well onsite or channeled from a pipeline, it is desirable to treat the gas with a gas scrubber prior to a gas compression step. This gas scrubbing will help in removing traces of liquid droplets from this recovered gas stream. The removal of these liquid droplets is done in order to protect downstream equipment from damage and failure. The gas scrubbing step is also desirable to perform prior to using gas from a pipeline.

The person skilled in the art will understand that the present invention should not be understood to be limited to oil well stimulation but also to gas well stimulation, natural gas well stimulation as well as for the stimulation of any hydrocarbon-bearing formation. The person skilled in the art will also understand that the mobile system described herein is not limited to requiring two compressor units but can be operated, according to the situation and well parameters, using one, two or more compressor units so long as the required pressure of at least 7,000 psi can be attained. Preferably, so long as the pressure of 9,000 psi is attained. More preferably, so long as a pressure of 13,000 psi is attained. Moreover, according to a preferred embodiment of the present invention, the mobile gas compression system can be used along with a fluid-based concurrent program in performing well stimulation. According to another preferred embodiment, the mobile gas compression system can be utilized in the performance of various other types of enhanced oil recovery operations as are known to the person skilled in the art.

According to an aspect of the invention, there is provided a mobile system for compressed gas well stimulation, said mobile system comprising:
a gas compression unit comprising:
   an inlet operatively connected to a source; and
   a compressor adapted to compress the gas to a pressure of no less than 7,000 psi; and
   an outlet adapted to be operatively connected to a well to perform well stimulation.

According to a preferred embodiment of the invention, the mobile system will further comprise a power source adapted to generate sufficient energy to power the compressor to reach the above defined pressure.

According to another aspect of the present invention, the mobile system for fluid compression can be used in enhanced oil recovery (EOR) operations as well as in fracking operations.

Although a few embodiments have been described, it will be appreciated to those skilled in the art that various changes and modifications can be made to the embodiments described herein. The terms and expressions used in the above description have been used herein as terms of description and not of limitation, and there is no intention in the use of such terms and expressions of excluding equivalents of the features shown and described or portions thereof, it being recognized that the invention is defined and limited only by the claims that follow.

What is claimed is:

1. Mobile system for compressed gas well stimulation, said mobile system comprising:
a first gas compression unit; said first gas compression unit comprising:
an inlet operatively connected to a source;
a first compressor adapted to compress the gas to a high pressure; and
an outlet;
a second gas compression unit; said second gas compression unit comprising:
an inlet operatively connected to the outlet of the first gas compression unit;
a second compressor adapted to compress the compressed gas to a pressure of no less than 7,000 psi; and
an outlet adapted to be operatively connected to a well to perform well stimulation.

2. The mobile system according to claim 1, wherein said compressed gas can reach pressures of no less than 9,000 psi.

3. The mobile system according to claim 1, wherein said compress gas can reach pressures of no less than 13,000 psi.

4. The mobile system according to claim 1, wherein the first gas compression unit is on a first trailer and the second gas compression unit is on a second trailer.

5. The mobile system according to claim 1, further comprising a power source operatively connected to both first and second gas compression units.

6. The mobile system according to claim 1, wherein at least one of the two gas compression units further comprise a coolant system operatively connected to the compression unit.

7. The mobile system according to claim 1, wherein said second compression unit comprises a motor located side-by-side with the second compressor on a trailer to allow said mobile system to be transported on conventional roadways.

8. The mobile system according to claim 1, wherein the second compressor is a reciprocating compressor.

9. The mobile system according to claim 1, wherein the gas to be compressed is obtained from an onsite source.

10. The mobile system according to claim 1, wherein the gas is recovered from an existing well and fed to the first gas compression unit.

11. A method for well stimulation by injection of compressed gas, said method comprising:
providing a mobile system for compression of gas up to a pressure of no less than 7,000 psi, said mobile system comprising:
a gas compression unit; said gas compression unit comprising an inlet operatively connected to a source and an outlet operatively connected to a well for downhole injection of said compressed gas while under substantially the high pressure reached during the compression;
providing a source of gas;
fluidly connecting the source of gas with the mobile unit for gas compression;
flowing the gas to the mobile system for compression of gas;
compressing the gas up to a pressure of not less than 13,000 psi; and
injecting the compressed gas into a well to be stimulated.

12. The method according to claim 11, wherein said gas is compressed up to a pressure of no less than 9,000 psi.

13. The method according to claim 11, wherein said gas is compressed up to a pressure of no less than 13,000 psi.

14. Mobile system for compressed gas well stimulation, said mobile system comprising:
a trailer adapted for the transport of a gas compression unit fixedly mounted thereon, said trailer being adapted for transport on conventional roadways, said gas compression unit comprising:
an inlet operatively connected to a gas source;
a compressor adapted to compress gas to high pressures; and
an outlet adapted to be operatively connected to a well for downhole injection of said gas while under substantially the high pressure reached during the compression by the compressor;
wherein, when in operation, said compressed gas is injected into a well at a pressure of no less than 7,000 psi.

15. Mobile system according to claim 14, wherein the gas is methane.

16. Mobile system according to claim 14, wherein the gas is comingled with a liquid.

17. Use of a mobile system for the compression of a fluid in enhanced oil recovery operations or in gas well stimulation, said mobile system comprising:
a trailer adapted for the transport of a fluid compression unit fixedly mounted thereon, said trailer being adapted for transport on conventional roadways, said gas compression unit comprising:
an inlet operatively connected to a fluid source;
a compressor adapted to compress a fluid to high pressures; and
an outlet adapted to be operatively connected to a well for downhole injection of said fluid while under substantially the high pressure reached during the compression by the compressor;
wherein, when in operation, said compressed fluid is injected into a well at a pressure of no less than 7,000 psi.

18. A method for well stimulation by injection of compressed gas, said method comprising:
providing a mobile system for compression of gas up to a pressure of no less than 7,000 psi, said mobile system comprising:
a first gas compression unit; said first gas compression unit being operatively connected to a source;
a second gas compression unit; said second gas compression unit being operatively connected to the first unit and having an outlet adapted to be operatively connected to a well for downhole injection of said gas while under substantially the high pressure reached during the compression by the second unit;
providing a source of gas;
fluidly connecting the source of gas with the mobile system for compression of gas;
flowing the gas to the mobile unit for gas compression;
compressing the gas up to a pressure of not less than 7,000 psi; and
injecting the compressed gas into a well to be stimulated.

19. The method according to claim 18, wherein said gas is compressed up to a pressure of no less than 9,000 psi.

20. The method according to claim 18, wherein said gas is compressed up to a pressure of no less than 13,000 psi.
